(19) United States
(12) Patent Application Publication
(10) Pub. No.: US 2022/0222604 A1
(43) Pub. Date: Jul. 14, 2022

(54) FEEDBACK VISUALIZATION TOOL

(71) Applicant: Target Brands, Inc., Minneapolis, MN (US)

(72) Inventors: MATT SCHILZ, Minneapolis, MN (US); STANLEY EBENEZER, Bengaluru (IN); ASIM KUMAR KANUNGO, Minneapolis, MN (US); JOSE DENZYL MONTEIRO, Minneapolis, MN (US)

(21) Appl. No.: 17/145,948

(22) Filed: Jan. 11, 2021

(51) Int. Cl. G06Q 10/06; G06F 16/28; G06F 16/26; G06N 20/00; G06F 40/247

(52) U.S. Cl. CPC G06Q 10/06395; G06F 16/287; G06F 40/247; G06N 20/00; G06F 16/26

(57) ABSTRACT

Feedback aggregation and visualization is provided. A feedback insights and visualization system collects feedback records received from a plurality of different channels, and uses a modifiable and customizable synonyms list to automatically aggregate related feedback that may be described using a variety of terminology within unstructured text to ensure that insights, such as trends, common issues, and/or issues and solutions across an enterprise are represented and discoverable in aggregated feedback. For example, the synonyms list allows for commonly-unrelated terminology to be linked, such that associated subtopics-of-interest may be detected and visually represented in a data visualization, wherein display attributes of the subtopics-of-interest are indicative of the frequency of inclusion of the terminology across collected feedback records.

### TECHNICAL FIELD

The present disclosure relates generally to a feedback visualization tool.

### BACKGROUND

Across various enterprises, feedback is oftentimes collected as part of improving business. For example, an enterprise may collect and review feedback from a plurality of different audiences to gain an understanding of wants and needs of its customers, employees, and/or other business partners and/or affiliates, and may further collect feedback to identify customers' level of satisfaction with products or services. Such feedback is usually submitted as unstructured text, which may include a variety of terminology and may not specifically identify a particular product, service, or issue for which the feedback is being provided. As can be appreciated, this can make it difficult to determine when multiple pieces of feedback may be related to a particular product, service, or issue, and can result in erroneously excluding relevant content from being properly aggregated. As such, an enterprise may be unable to gain a holistic view of received feedback, ideas, and/or suggestions, which can prevent the enterprise from discovering and implementing measures that may allow the business to operate more efficiently and/or to otherwise improve business.

### SUMMARY

In summary, the present disclosure relates to methods, systems, and a computer readable storage device for providing feedback insights and visualization. In the context of the present disclosure, a feedback insights and visualization system is provided that collects feedback received from a plurality of different channels, and uses a modifiable and customizable synonyms list to automatically aggregate related feedback that may be described using a variety of terminology within unstructured text to ensure that insights, such as trends, common issues, and/or issues and solutions across an enterprise, are represented and discoverable in aggregated feedback. This allows for a visualization of insights to be generated and displayed in a user interface and for various systems to make determinations about trends and issues within an enterprise from a holistic vantage point. Various aspects are described in this disclosure, which include, but are not limited to, the following aspects.

In one aspect, a system for providing feedback insights and visualization includes a computing system that includes at least one processor and a memory communicatively coupled to the at least one processor such that when instructions stored on the memory are executed by the at least one processor, operate to: store, in a synonyms list, a terminology grouping comprising at least a first term and a second term, wherein inclusion of the first term and the second term in the terminology grouping causes the terms to be linked together and to a subtopic-of-interest; receive a plurality of feedback records from a plurality of different feedback sources; and in response to an indication of a selection of a topic-of-interest: determine feedback records associated with the topic-of-interest; identify, in the feedback records determined to be associated with the topic-of-interest, an inclusion of the first term or the second term; determine metrics associated with the feedback records determined to be associated with the topic-of-interest, wherein the metrics include a frequency of inclusion of the first term or the second term in the feedback records; and generate a data visualization for display in a user interface, the data visualization including the subtopic-of-interest, wherein display attributes of the subtopic-of-interest are indicative of the frequency of inclusion of the first term or the second term in the feedback records determined to be associated with the topic-of-interest.

In another aspect, a method of providing feedback insights and visualization comprises: storing, in a synonyms list, a terminology grouping comprising at least a first term and a second term, wherein inclusion of the first term and the second term in the terminology grouping causes the terms to be linked together and to a subtopic-of-interest; receiving a plurality of feedback records from a plurality of different feedback sources; and in response to receiving an indication of a selection of a topic-of-interest: determining feedback records associated with the topic-of-interest; identifying, in the feedback records determined to be associated with the topic-of-interest, an inclusion of the first term or the second term; determining metrics associated with the feedback records determined to be associated with the topic-of-interest, wherein the metrics include a frequency of inclusion of the first term or the second term in the feedback records; and generating a data visualization for display in a user interface, the data visualization including the subtopic-of-interest, wherein display attributes of the subtopic-of-interest are indicative of the frequency of inclusion of the first term or the second term in the feedback records determined to be associated with the topic-of-interest.

In another aspect, a computer-readable storage device comprises computer-executable instructions which, when executed by a computing system, cause the computing system to perform a method of providing feedback insights and visualization, the method comprising storing, in a synonyms list, a terminology grouping comprising at least a first term and a second term, wherein inclusion of the first term and the second term in the terminology grouping causes the terms to be linked together and to a subtopic-of-interest; receiving a plurality of feedback records from a plurality of different feedback sources; and in response to receiving an indication of a selection of a topic-of-interest: determining feedback records associated with the topic-of-interest; identifying, in the feedback records determined to be associated with the topic-of-interest, an inclusion of the first term or the second term; determining metrics associated with the feedback records determined to be associated with the topic-of-interest, wherein the metrics include a frequency of inclusion of the first term or the second term in the feedback records; and generating a data visualization for display in a user interface, the data visualization including the subtopic-of-interest, wherein display attributes of the subtopic-of-interest are indicative of the frequency of inclusion of the first term or the second term in the feedback records determined to be associated with the topic-of-interest.

### BRIEF DESCRIPTION OF THE DRAWINGS

FIG. 1 is a block diagram of an example operating environment for a feedback system according to an embodiment;

FIG. 2 is a block diagram of an example schematic diagram of an example feedback system according to an embodiment;

FIG. 3 is an illustration of an example synonyms list;

FIGS. 4A and 4B are illustrations of an example user interface including a visual representation of subtopics-of-interest identified as associated with a user-selected topic-of-interest;

FIG. 5 is a flow chart depicting general stages of an example method for providing flexible feedback aggregation and visualization; and

FIG. 6 is a block diagram of an example computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. In general, the present disclosure relates to a system and method for providing flexible feedback aggregation and visualization. More specifically, the present disclosure relates to a system and method for providing commonly-unrelated terminology aggregation for flexible categorization of feedback related to a topic-of-interest and collected from a plurality of feedback sources across different feedback channels. The system and method include utilization of a synonyms list for providing a linkage of terms that may ordinarily be unrelated and for generating a data visualization representing at least a frequency of inclusion of the terms in received feedback related to the topic-of-interest. The data visualization enables a user of the system to easily identify or detect common issues or issues and solutions across multiple enterprise locations and/or other enterprise divisions.

In general, the present application relates to a feedback aggregation and presentation tool. More particularly, the present disclosure describes a system, method, and a computer readable storage device for providing commonly-unrelated terminology aggregation for generating a subtopic-of-interest data visualization based on the commonly-unrelated terminology aggregation that enables a detection of common issues or issues and solutions across multiple enterprise locations.

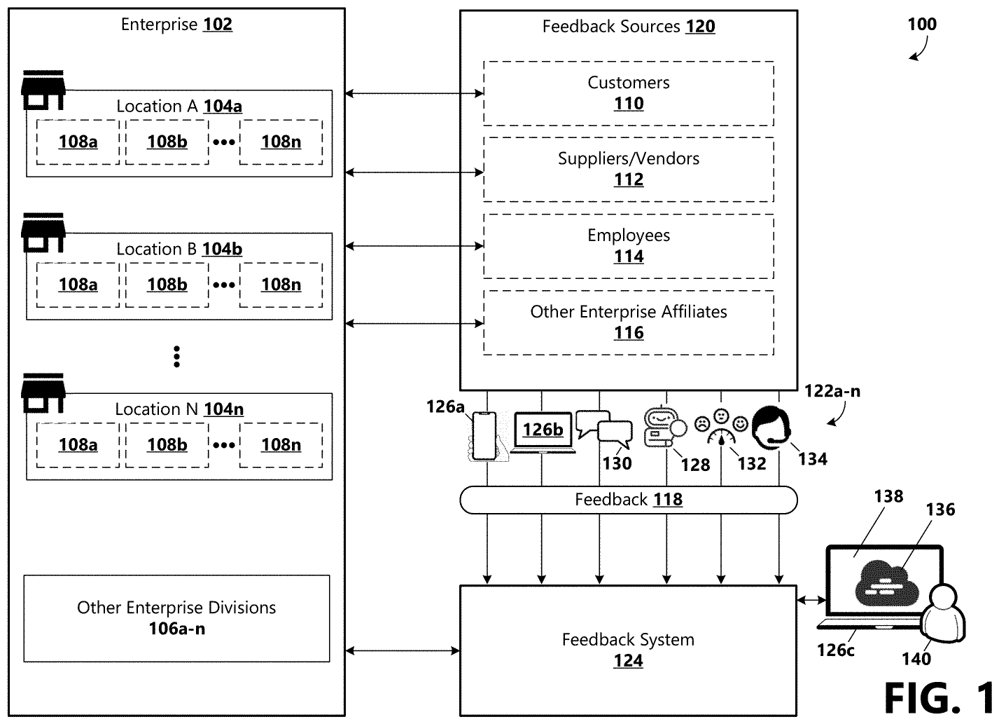

FIG. 1 is a schematic diagram of an example operating environment 100 for flexible feedback aggregation and visualization. The example operating environment 100 includes an enterprise 102 that is comprised of multiple locations 104a-n (generally 104) and/or other enterprise-level divisions 106a-n (generally 106), such as departments, operation centers, etc., that all collaborate to achieve big-picture business objectives. Each location 104 or division 106 may be comprised of further divisions (i.e., sub-divisions 108a-n (generally 108)). According to one illustrative example, the enterprise 102 is a retail enterprise that provides a flow of inventory from a vendor/supplier 112 to a customer 110. The retail enterprise 102 may include various retail locations 104, and may be further comprised of other enterprise divisions 106, such as a headquarters and one or more operation centers (e.g., inventory receive centers, flow centers). Although examples are presented primarily regarding the retail industry, these are presented as non-limiting examples, as enterprises 102 in other goods, service, healthcare, educational, professional, and other industries may also make use of the present disclosure.

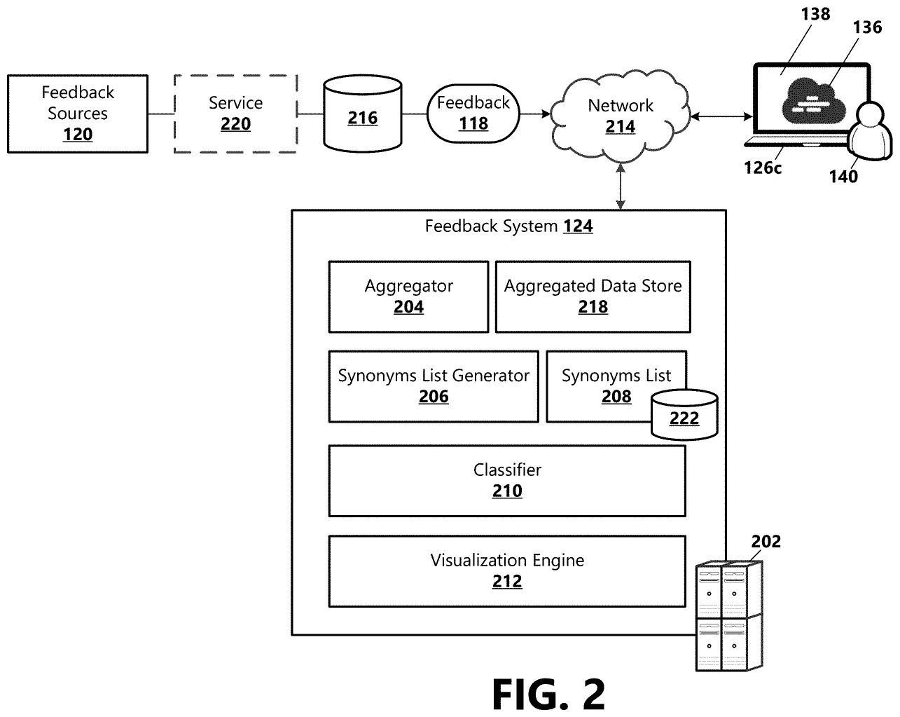

According to an aspect, the enterprise 102 may collect feedback records 118 from a plurality of feedback sources 120 to improve business (e.g., improve efficiencies, reduce inefficiencies, improve customer satisfaction, improve employee satisfaction). For example, the enterprise 102 may collect feedback records 118 to gain an understanding of wants and needs of its customers 110, employees 114, and/or other enterprise affiliates 116, and may further collect feedback records 118 to identify customers' level of satisfaction with products and/or services. Feedback records 118 may be submitted voluntarily, in response to a request for feedback, and/or as part of a recording (with permission) of a conversation (e.g., help session, chat session, customer service session). In some examples, a feedback record 118 may be requested in association with a particular product, service, or user experience with the enterprise 102. The feedback records 118 can be submitted by a plurality of different feedback sources 120 (e.g., customers 110, employees 114, and/or other enterprise affiliates 116) via a variety of feedback channels 122a-n (generally 122). In some examples, such channels 122 can include using a telephone or phone application operating on a computing device 126 to provide, via a voice call, a feedback record 118 to a feedback insights and visualization system, herein referred to as a feedback system 124 (e.g., in association with a voice call to a customer service agent 134). In other examples, the channels 122 can include using a computing device 126, such as a mobile phone/computing device 126a, a desktop or laptop computing device 126b, or other type of computing device 126 to provide a feedback record 118 to the feedback system 124. For example, the computing device 126 may communicate with a network, which communicates with a server computer of the feedback system 124 where the feedback records 118 may be aggregated and stored. In some examples, one or more intermediary server computers (e.g., a server computer associated with a service 220 (FIG. 2)) may receive, process, and store (e.g., in a data store 216) submitted feedback records 118 prior to being aggregated and stored by the feedback system 124.

According to one example, a customer 110 may use a computing device 126, such as a mobile phone 126a, to access a help function, wherein a feedback record 118 may be received in association with the customer 110 using the help function. In some examples, the help function may operate in conjunction with a chatbot 128. As another example, a customer 110 may use a computing device 126, such as a desktop or laptop computer 126b, to access a support function, wherein feedback record 118 may be provided by the customer 110 in association with using the support function. As another example, a customer 110 may use a computing device 126 to access a webpage of the enterprise 102 to provide a feedback record 118 via a feedback module. As another example, another enterprise affiliate 116, such as a transportation or delivery worker, may provide a feedback record 118 in association with transporting inventory to the enterprise 102 or to a customer 110. As another example, a customer 110 may use a telephone or phone application operating on a computing device 126 to speak with a customer service agent 134 (e.g., via a voice call), and a feedback record 118 in association with the voice call with the customer service agent 134 may be captured and/or provided. As another example, a customer 110, supplier/vendor 112, employee 114, or other enterprise affiliate 116 may provide a feedback record 118 via a survey 132 (e.g., an online survey, a phone survey, an in-person survey). In some examples, the survey 132 may be in association with a purchased product or service, and may identify the product or service by its brand name or using other terminology. In other examples, the survey 132 may be in association with a particular user experience with the enterprise 102, such as an in-person experience at an enterprise location 104, an online experience, a telephone call experience, a delivery experience, or an experience with another enterprise division 106. The user experience may be experienced by one of various types of affiliates of the enterprise 102, such as a customer 110, a supplier/vendor 112, employee 114, or other enterprise affiliate 116. As another example, an employee 112 may provide a feedback record 118 via utilization of an employee chat function 130. As should be appreciated, the above examples are presented as non-limiting examples. Other feedback sources 120 and/or feedback channels 122 are possible and are within the scope of the present disclosure.

According to an aspect, a feedback record 118 may be provided/submitted as unstructured text. Unstructured text may include a variety of terminology and may or may not specifically identify a particular product, service, or issue for which the feedback record 118 is being provided. For example, terminology used in unstructured text included in submitted feedback records 118 may vary based on the feedback source 120, a location/region in association with the feedback source 120, the division of the enterprise 102 (e.g., store/location 104, and/or other enterprise division 106) in association with submitted feedback records 118, the product, service, or issue for which a feedback record 118 is being submitted, or other reason. As can be appreciated, variations in terminology used in unstructured text can make it difficult to determine when multiple pieces of feedback records 118 may be related to a particular product, service, or issue. Moreover variations in terminology used in unstructured text can make it difficult to properly aggregate that terminology according to a unified set of categorized content that can easily be displayed based on a selectable subset of the data (e.g., by store/location 104 or region) to identify a subtopic-of-interest, such as a common or specific issue encountered by customers 110, suppliers/vendors 112, employees 114, and/or other enterprise affiliates 116. For example, as a result of difficulties in properly aggregating terminology, feedback records 118 relevant to a subtopic-of-interest may not be determined as relevant and may be excluded from a presentation or analysis of feedback associated with a topic-of-interest. Accordingly, the enterprise 102 may be unable to gain a holistic view of received feedback records 118, ideas, and/or suggestions, which can prevent the enterprise 102 from discovering and implementing measures that may allow the business to operate more efficiently and/or to otherwise improve business. To overcome at least the above problems with accurately identifying feedback topics-of-interest, the feedback system 124 of the present disclosure is configured to provide flexible feedback aggregation and visualization based on a modifiable and customizable synonyms list, which enables a rich text search to be performed across all columns of data and a data visualization 136 associated with related feedback to be generated and displayed in a user interface 138 of a computing device 126c. For example, the feedback system 124 of the present disclosure is configured to generate and extract insights from unstructured text received from a plurality of different audiences, and the data visualization 136 enables users 140 to easily identify subtopics-of-interest that are relevant to a topic-of-interest. Example components of the feedback system 124 and operations of the components are described below.

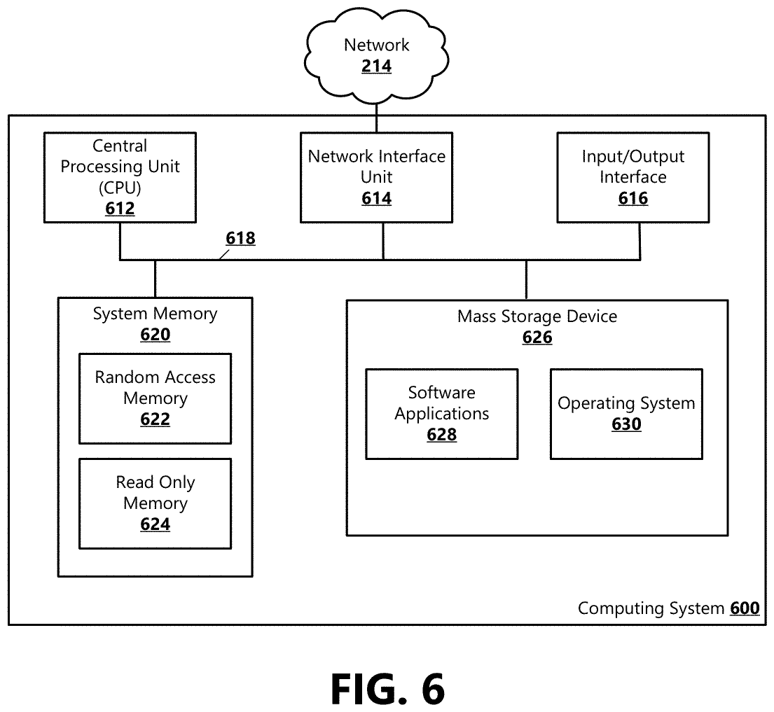

FIG. 2 is a schematic diagram of an example feedback system 124 according to an embodiment. With reference now to FIG. 2, the example feedback system 124 comprises various subsystems including: an aggregator 204, an aggregated data store 218, a synonyms list generator 206, a synonyms list 208, a classifier 210, and a visualization engine 212. Each of the subsystems may be implemented as one or more separate computing systems 600 (FIG. 6), software applications, program modules, or the like.

The aggregator 204 is operative or configured to aggregate feedback records 118 submitted from various feedback sources 120 and received via various feedback channels 122. The aggregator 204 is configured to access a data store 216 configured to house received feedback records 118. According to an aspect, at least a portion of the feedback records 118 includes unstructured text. In some examples, at least a portion of feedback records 118 received from feedback sources 120 may be received by a service 220, such as a publish-subscribe messaging system, and then stored in the data store 216. In other examples, at least a portion of feedback records 118 received from feedback sources 120 may be published to the data store 216 via utilization of an application programming interface (API). For example, the data store 216 may provide an API that allows the feedback channel 122 to communicate with the data store 216 for storage of feedback records 118. In other examples, the feedback system 124 may expose an API via which feedback records 118 can be automatically received and processed by the feedback system 124 as described below.

In various aspects, as part of aggregating feedback records 118, the aggregator 204 is operative or configured to capture a set of parameters around unstructured text included in a feedback record 118, and store the parameters in association with the unstructured text in an aggregated data store 218. In some examples, the aggregated data store 218 is a data table. In some examples, the set of parameters may include at least an identification of a particular enterprise location 104 (e.g., a retail store location). In some examples, the set of parameters may include at least an identification of a particular issue or topic that the submitted feedback record 118 is concerned (e.g., an out-of-stock item, a delivery issue). In some examples, the set of parameters may further include an identification of other/additional aspects about a received feedback record 118. In some examples, the aggregator 204 is operative or configured to apply, to feedback data, metadata tags corresponding to the parameters.

The synonyms list generator 206 is operative or configured to receive and store, in a synonyms list 208, a listing of grouped or linked words/terminology, wherein the grouped or linked words/terminology may otherwise be considered separate and unrelated. According to an aspect, the synonyms list 208 is modifiable and customizable. The synonyms list 208 may be stored in a data store 222 included in or in communication with the feedback system 124. According to an example, a feedback record 118 received from a first feedback source 120 may include unstructured text that uses wording/terminology to describe a product/inventory item, service, experience, or other enterprise function that varies from wording/terminology used in another feedback record 118 received from a second feedback source 120 to describe the same or a similar product/inventory item, service, experience, or other enterprise function. In various aspects, the varying wording/terminology used in two different feedback records 118 may normally be considered separate and/or unrelated; however, when the varying wording/terminology are included and grouped/linked in the synonyms list 208, feedback records 118 that include the varying wording/terminology may then be determined to be related.

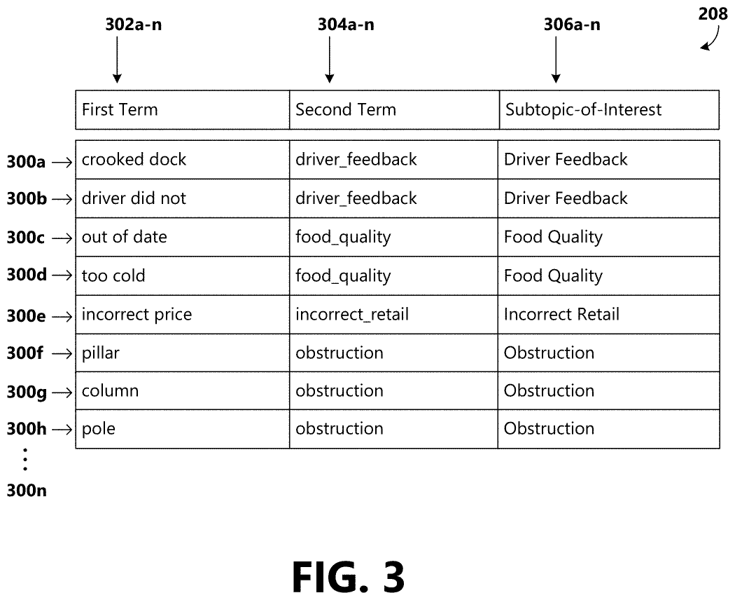

An example synonyms list 208 is illustrated in FIG. 3. With reference to FIG. 3, the example synonyms list 208 includes a plurality of terminology groupings 300a-n (generally 300), wherein each terminology grouping 300 includes at least a first term 302a-n (generally 302) and a second term 304a-n (generally 304), and the inclusion of the terms 302,304 in the terminology grouping 300 causes the terms 302,304 to be linked for aggregating feedback records 118 according to an associated subtopic-of-interest 306a-n (generally 306). In some examples, the subtopic-of-interest 306 is the second term 304. In other examples, the subtopic-of-interest 306 is a normalized term. According to an aspect, the first term 302 or the second term 304 can include one or a combination of a single word, a plurality of words, a phrase, an abbreviation, an acronym, numbers, spaces, special characters, symbols, etc. As will be described below, a plurality of subtopics-of-interest 306 may be determined as associated with feedback records 118 about a particular issue or topic, a particular enterprise location 104, a region comprised of a plurality of enterprise locations 104, a particular enterprise location subdivision 108, or a particular other enterprise division 106, etc. The plurality of subtopics-of-interest 306 may be presented in a user interface 138, and when a subtopic-of-interest 306 is selected, feedback records 118 that include the first term 302 or the second term 304 may be aggregated and presented as output to a user 140. According to an aspect, the synonyms list 208 provides an additional layer of customization that can be applied across any search that allows for aggregating or treating as common words/terminology (i.e., terms 302,304) that may otherwise be considered unrelated.

As a first example, a first grouping 300a may link or associated a first term 302a “crooked dock” with a second term 304a “driver_feedback.” As a second example, in a second grouping 300b, a different first term 302a “driver did not” may be linked/associated with a second term 304b “driver_feedback.” In this example, the second term 304b “driver_feedback” is the same as the second term 304a “driver_feedback” in the first example grouping 300a. Thus, multiple first terms 302 can be linked or associated with a particular second term 304, and may be further linked or associated with a particular subtopic-of-interest 306 term that is displayed to a user 140 in a user interface 138. Similarly, in third and fourth example groupings 300c,d, different first terms 302c,d “out of date” and “too cold” are both linked to the same second term 304c,d “food_quality,” and in fifth, sixth, and seventh example groupings 300e,f,g,h, different first terms 302e,f,g,h “pillar,” “column,” and “pole” are linked to the same second term 304e,f,g,h “obstruction.” As can be appreciated, the first terms 302 and second terms 304 that are linked in the example groupings 300 may, in various contexts, be otherwise considered as unrelated.

In some examples, the synonyms list generator 206 is operative or configured to receive a manual user-entry of two or more terms 302,304 and to store the two or more terms 302,304 in a grouping 300 such that the two or more terms 302,304 are linked. In other examples, the synonyms list generator 206 is operative or configured to generate the synonyms list 208 based on a set of business rules. In other examples, the synonyms list generator 206 is operative or configured to use supervised machine learning methods to learn, based on a training dataset, a mapping function from an input variable to an output variable, wherein the mapping function can be applied to identify and group/link two or more terms 302,304 in the synonyms list 208. The training dataset can include previously-linked terms 302,304. In other examples, the synonyms list generator 206 is operative or configured to use unsupervised machine learning methods to discover inherent groupings of two or more terms 302,304 in feedback records 118. In other examples, the synonyms list generator 206 is operative or configured to use semi-supervised machine learning methods to generate the synonyms list 208.

With reference again to FIG. 2, the classifier 210 is operative or configured to receive an indication of a request for feedback output associated with a topic-of-interest, and to generate a query on the aggregated data store 218 for feedback content related to the topic-of-interest. According to some aspects, the topic-of-interest corresponds to a metadata tag applied to a feedback record 118 stored in the aggregated data store 218. As an example, a topic-of-interest may be a particular issue or topic, a particular enterprise location 104, a region comprised of a plurality of enterprise locations 104, a particular enterprise location subdivision 108, or a particular enterprise division 106, etc., about which the submitted feedback record 118 is concerned. For example, the classifier 210 may perform a search on metadata tags for a parameter associated with the topic-of-interest, and determine search results comprising one or more feedback records 118 that match the topic-of-interest.

In some examples, the classifier 210 is further operative or configured to perform a text mining operation for discovering terms 302,304 included in the determined search results. In other examples, a text mining operation may be performed prior to receiving an indication of a request for feedback output associated with a topic-of-interest, and keywords may be extracted from and stored in association with the feedback record 118 from which they are extracted in the aggregated data store 218. In various aspects, the classifier 210 is further operative or configured to normalize the discovered terms 302,304 to their associated subtopics-of-interest 306 terms, and provide the search results comprising feedback records 118 that match the topic-of-interest and the subtopics-of-interest 306 to the visualization engine 212 for presentation to a user 140.

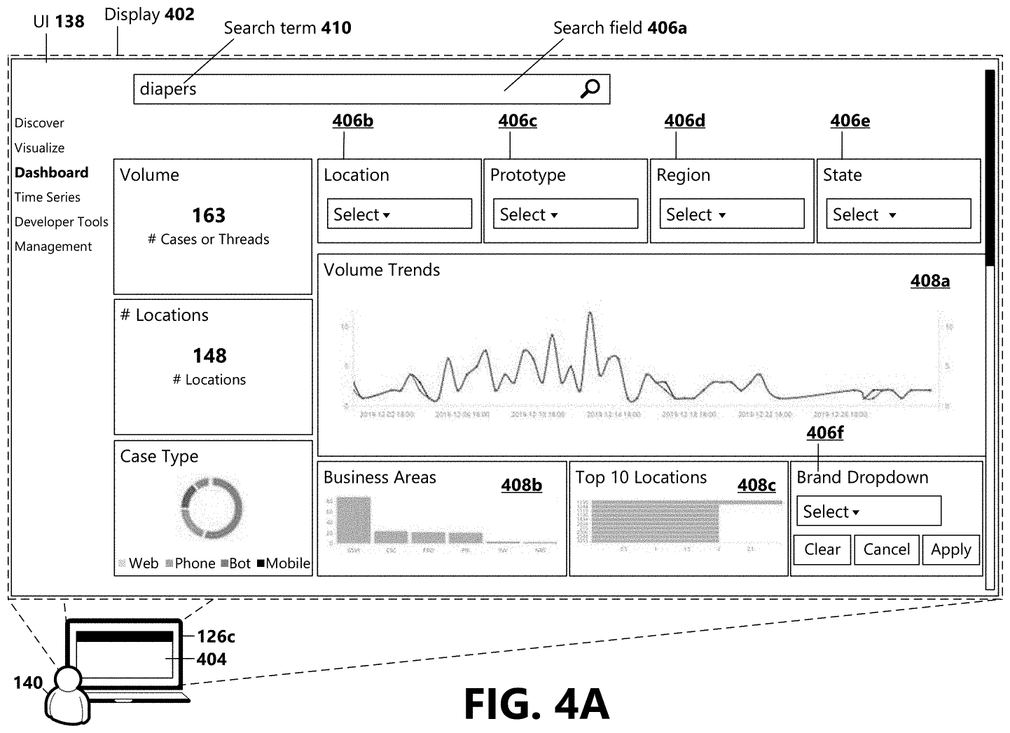

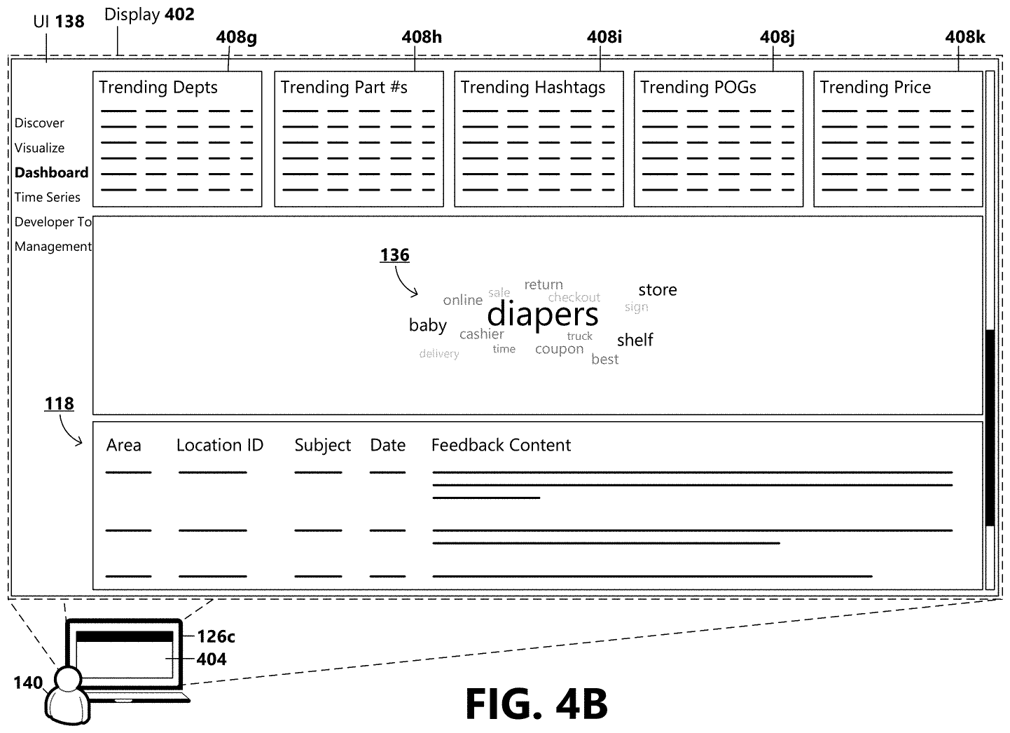

The visualization engine 212 is operative or configured to provide the user interface 138 with which a user 140 interacts and via which feedback output is presented to the user 140. An example user interface is illustrated in FIGS. 4A and 4B. With reference to FIG. 4A, an example user interface 138 is shown displayed on a display 402 of a computing device 126c of a user 140. The computing device 126c may execute a front-end application 404, which can be implemented as a thick client application, which may be stored locally on the computing device 126c or implemented as a thin client application (i.e., web application) that may reside on a remote server 202 and be accessible over a network 214 or combination of networks (e.g., the Internet, wide area networks, local area networks, software defined networks). The front-end application 404 is configured to communicate with the feedback system 124. The computing device 126c may be one of various types of computing devices (e.g., a server device, a desktop computer, a tablet computing device, a mobile device, a laptop computer, a laptop/tablet hybrid computing device, a large screen multi-touch display, or other type of computing system) configured to execute instructions for performing a variety of tasks.

According to an aspect, the visualization engine 212 is configured to provide, in the user interface 138, one or more search fields 406a-f (generally 406) via which the user 140 can enter or select one or more search criteria/terms 410. For example, an entered or selected search term 410 may be received by the front-end application 404 and communicated to the feedback system 124, where it is received as an indication of a request for feedback output associated with the search term 410. According to some aspects, the search term 410 may be related to a particular issue or topic, a particular brand name, a particular item or service, a particular enterprise location 104, a region comprised of a plurality of enterprise locations 104, a particular enterprise location subdivision 108, or a particular enterprise division 106, etc., about which the submitted feedback record 118 is concerned. That is, the search term 410 may be identified as the topic-of-interest, and in response to receiving the search term 410, the classifier 210 may generate a query on the aggregated data store 218 for feedback content related to the search term 410/topic-of-interest as described above. Although described as a search field 406, in other examples, the search term 410 can be received via alternate user interface methods (e.g., selection of a displayed topic-of-interest, voice input). Further, as described above, the classifier 210 may perform a text mining operation to discover terms 302,304 included in the query/search results based on the synonyms list 208, extract and normalize the discovered terms 302,304 to their associated subtopics-of-interest 306 terms (based on the synonyms list 208), and provide the query/search results comprising feedback records 118 that match the topic-of-interest and the subtopics-of-interest 306 to the visualization engine 212.

According to various aspects, the visualization engine 212 is further operative or configured to receive, from the classifier 210, the query/search results comprising feedback records 118 that are determined to be related to the topic-of-interest and the associated subtopics-of-interest 306, determine metrics associated with the related feedback records 118, and update the user interface 138. For example and as illustrated in FIGS. 4A and 4B, the visualization engine 212 may update the user interface 138 to include a display of one or a combination of: the related feedback records 118, the metrics 408a-k (generally 408), and a graphic data visualization 136 of the subtopics-of-interest 306 discovered in the feedback records 118. In some examples and as illustrated in FIG. 4B, the data visualization 136 of the subtopics-of-interest 306 is a word cloud. For example, the data visualization 136 may be an image comprised of words, wherein the words are the subtopics-of-interest 306 determined to be associated with the entered or selected search term(s) 410/topic(s)-of-interest based on the synonyms list 208, and the display attributes (e.g., size and color/shade intensity) of each word is indicative of its frequency of inclusion (e.g., as the first term 302, the second term 304, or the subtopic-of-interest 306 term) in the related feedback records 118. As can be appreciated, the frequency of inclusion may be an indicator of the importance of a word/subtopic-of-interest 306. According to an aspect of the present disclosure, utilization of the synonyms list 208 provides a linkage of terms 302,304 that may ordinarily be unrelated, which enables the visualization engine 212 to generate an accurate representation of the frequency of inclusion of the terms 302,304 and further enables a user 140 of the feedback system 124 to easily identify or detect common issues or issues and solutions across multiple enterprise locations 104 and/or other enterprise divisions 106. As should be appreciated, the user interface 138 is not limited to the above examples and can include additional and/or alternative information.

In example embodiments, the visualization engine 212 may be implemented, in whole or part, using one or more open source data visualization libraries. For example, in some embodiments, the visualization engine 212 may use a data visualization dashboard such as Kibana, an open source visualization tool from Elastic NV of Mountain View, Calif. Other types of data visualization tools may be used as well.

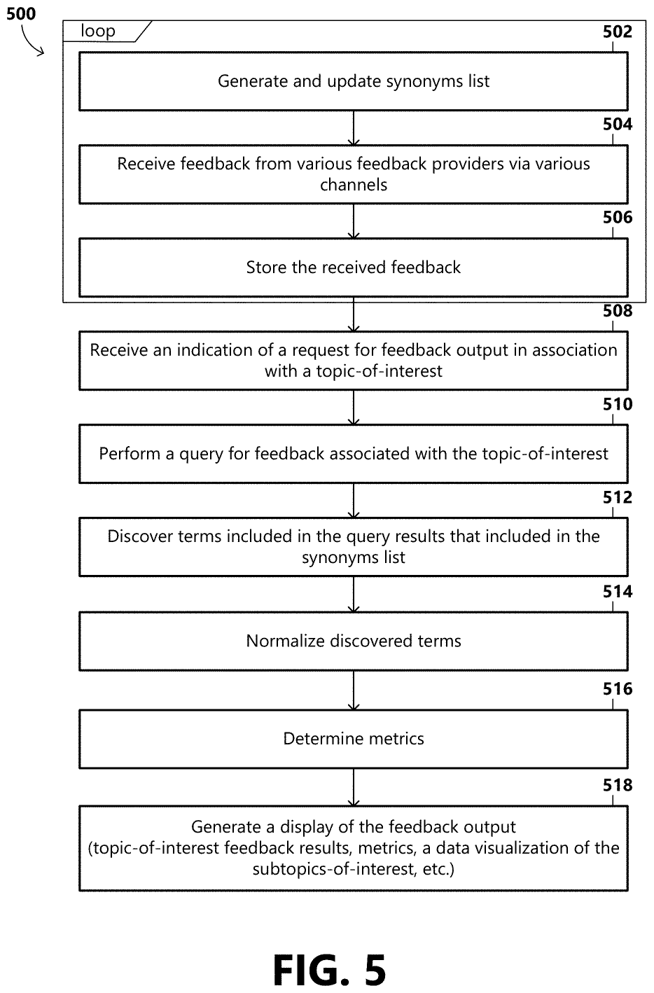

FIG. 5 is a flow diagram depicting general stages of an example method 500 for providing flexible feedback aggregation and visualization according to an embodiment. At OPERATION 502, a synonyms list 208 is generated and maintained (e.g., updated). The synonyms list 208 is comprised of a plurality of terminology groupings 300, wherein each terminology grouping 300 includes at least a first term 302 and a second term 304, and the inclusion of the terms 302,304 in the terminology grouping 300 causes the terms 302,304 to be linked for aggregating feedback records 118 according to the terms 302,304. In some examples, a terminology grouping 300 further includes a subtopic-of-interest 306, which may be the second term 304 or a normalized term. The synonyms list 208 may be generated manually, based on a set of business rules, using supervised, unsupervised, and/or semi-supervised machine learning methods. The synonyms list 208 may be stored in a data store 222.

At OPERATION 504, a plurality of feedback records 118 may be received from a plurality of different audiences (i.e., different feedback sources 120) via a plurality of different feedback channels 122. The feedback records 118 may include unstructured text, and due at least in part to the variation of feedback sources 120 and/or the feedback channels 122 used to receive the feedback records 118, the language/terminology used in the unstructured text may differ although the records may include feedback content that are related. As an be appreciated, utilization of different language/terminology across feedback records 118 can make it difficult to properly aggregate that terminology according to a unified set of categorized content that can easily be displayed based on a selectable subset of the data (e.g., by store or region) to identify common or specific issues encountered by customers 110, suppliers/vendors 112, employees 114, and/or other enterprise affiliates 116 in those areas.

At OPERATION 506, received feedback records 118 may be stored. In some examples, the feedback records 118 include a set of parameters around the unstructured text, and the parameters are stored in association with the unstructured text in the aggregated data store 218. In some examples, the parameters are stored as metadata tags. The set of parameters may include an identification of a particular enterprise location 104 (e.g., a retail store location), an identification of a particular issue or topic with which the submitted feedback record 118 is concerned (e.g., an out-of-stock item, a delivery issue), and/or an identification of other/additional aspects about a received feedback record 118. OPERATIONS 502-506 may be performed continually in a loop.

At OPERATION 508, an indication of a request for feedback output in association with an entered or selected search term 410/topic-of-interest is received. For example, a user 140 may utilize a frontend application 404 executing on a computing device 126c to enter or select a search term 410 that is related to a topic-of-interest, and the entered or selected search term 410 may be communicated to and received by the feedback system 124. In some examples, a plurality of search terms 410 or search criteria are entered or selected by the user 140. For example, the user 140 may wish to view feedback records 118 or metrics 408 about feedback records 118 associated with a particular location, prototype, region, state, brand, etc.

At OPERATION 510, in response to receiving the indication of the quest for feedback output in association with the entered or selected search term(s) 410/topic-of-interest, a query may be performed for feedback records 118 associated with the entered or selected search term(s) 410/topic-of-interest. Query results may include a plurality of feedback records 118 that match the search term(s) 410/topic-of-interest. In some examples, the query results include feedback records 118 that are determined to match based at least in part on the set of parameters stored in association with the unstructured text that identify at least one of: a particular enterprise location 104 (e.g., a retail store location), a particular issue or topic (e.g., an out-of-stock item, a delivery issue), and other/additional aspects about a received feedback record 118.

At OPERATION 512, a text mining process may be performed to discover, in the feedback record 118 results, differing terminology that may be used to describe a same or similar subtopic-of-interest 306. For example, when a term 302 is included in both the synonyms list 208 and in a feedback record 118 (included in the query results), the term 302 and any additional instances of the term 302 or its linked term 304 in the feedback record 118 results may be may be linked and normalized (OPERATION 514) to its associated subtopic-of-interest 306 term.

At OPERATION 516, various metrics are determined about the feedback records 118 that are determined to match the entered or selected search term(s) 410/topic-of-interest and the linked subtopics-of-interest 306 discovered in the feedback records 118. According to one example, an overall frequency of inclusion of a grouped term 302,304 or associated subtopic-of-interest 306 in the feedback records 118 may be determined.

At OPERATION 518, the user interface 138 displayed to the user 140 may be updated to include a display of one or a combination of: the related feedback records 118, the metrics 408, and a graphic data visualization 136 of the subtopics-of-interest 306 discovered in the feedback records 118. In some examples, the data visualization 136 is a word cloud comprised of the subtopics-of-interest 306 determined to be associated with the entered or selected search term 410/topic-of-interest based on the synonyms list 208, and the size and color/shade intensity of each word may be indicative of its frequency of inclusion in the feedback records 118. In some examples, the user 140 may be further enabled to select a subtopic-of-interest 306 included in the data visualization 136, wherein in response to the selection, the feedback records 118 that include the selected subtopic-of-interest 306 may be included in the user interface 138 for display to the user 140. Accordingly, the user 140 is enabled to accurately identify and drill down into common or specific issues encountered by its customers 110, employees 114, and/or other enterprise affiliates 116 for specific enterprise locations 104, regions, or other enterprise division 106.

Referring now to FIG. 6, an example block diagram of a computing system 620 is shown that is useable to implement aspects of the feedback system 124 of FIGS. 1 and 2. In the embodiment shown, the computing system 620 includes at least one central processing unit (“CPU”) 602, a system memory 608, and a system bus 632 that couples the system memory 608 to the CPU 602. The system memory 608 includes a random access memory (“RAM”) 610 and a read-only memory (“ROM”) 612. A basic input/output system that contains the basic routines that help to transfer information between elements within the computing system 620, such as during startup, is stored in the ROM 612. The computing system 620 further includes a mass storage device 614. The mass storage device 614 is able to store software instructions and data.

The mass storage device 614 is connected to the CPU 602 through a mass storage controller (not shown) connected to the system bus 632. The mass storage device 614 and its associated computer-readable storage media provide non-volatile, non-transitory data storage for the computing system 620. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 602 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 620.

According to various embodiments of the invention, the computing system 620 may operate in a networked environment using logical connections to remote network devices through a network 622, such as a wireless network, the Internet, or another type of network. The computing system 620 may connect to the network 622 through a network interface unit 604 connected to the system bus 632. It should be appreciated that the network interface unit 604 may also be utilized to connect to other types of networks and remote computing systems. The computing system 620 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the computing system 620 can store software instructions and data. The software instructions include an operating system 618 suitable for controlling the operation of the computing system 620. The mass storage device 614 and/or the RAM 610 also store software instructions, that when executed by the CPU 602, cause the computing system 620 to provide the functionality discussed in this document. For example, the mass storage device 614 and/or the RAM 610 can store software instructions that, when executed by the CPU 602, cause the computing system 620 to receive and analyze inventory and demand data.

Referring to FIGS. 1-6 generally, it is noted that the methods and systems have a number of advantages in terms of providing flexible feedback aggregation and visualization. For example, utilization of the synonyms list 208 provides a linkage of terms 302,304 that may ordinarily be unrelated, which enables the visualization engine 212 to generate an accurate visual representation of the frequency of inclusion of subtopics-of-interest associated with those terms included in feedback records 118 collected from across the operational spectrum of the enterprise 102. The visual representation (i.e., data visualization 136) enables a user 140 of the feedback system 124 to easily identify or detect common issues or issues and solutions across multiple enterprise locations 104 and/or other enterprise divisions 106, despite feedback being collected from a variety of disparate entities and via a variety of heterogeneous communication mechanisms.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A system for providing flexible feedback aggregation and visualization, comprising:
at least one processor; and
a memory coupled to the at least one processor, the memory including instructions that, when executed by the at least one processor, cause the system to:
store, in a synonyms list, a terminology grouping comprising at least a first term and a second term, wherein inclusion of the first term and the second term in the terminology grouping causes the terms to be linked together and to a subtopic-of-interest;
receive a plurality of feedback records from a plurality of different feedback sources; and
in response to an indication of a selection of a topic-of-interest:
determine feedback records associated with the topic-of-interest;
identify, in the feedback records determined to be associated with the topic-of-interest, an inclusion of the first term or the second term;
determine metrics associated with the feedback records determined to be associated with the topic-of-interest, wherein the metrics include a frequency of inclusion of the first term or the second term in the feedback records; and
generate a data visualization for display in a user interface, the data visualization including the subtopic-of-interest, wherein display attributes of the subtopic-of-interest are indicative of the frequency of inclusion of the first term or the second term in the feedback records determined to be associated with the topic-of-interest.

2. The system of claim 1, wherein the first term and the second term are otherwise separate and unrelated.

3. The system of claim 1, wherein the synonyms list is modifiable.

4. The system of claim 1, wherein prior to storing the terminology grouping in the synonyms list, the system is configured to receive the terminology grouping and the subtopic-of-interest as an input.

5. The system of claim 1, wherein in storing the terminology grouping in the synonyms list, the system is configured to generate the terminology grouping based on a business rule.

6. The system of claim 1, wherein in storing the terminology grouping in the synonyms list, the system is configured to use machine learning techniques to determine the terminology grouping.

7. The system of claim 1, wherein:
at least a portion of the plurality of feedback records are received via various feedback channels;
at least a portion of the plurality of feedback records include unstructured text; and
due at least in part to the plurality of feedback records being received from the plurality of different feedback sources or via various feedback channels, the unstructured text includes differing terminology to describe a related issue, the differing terminology including the first term and the second term.

8. The system of claim 1, wherein the indication of the selection of the topic-of-interest is a user-selection of at least one search term.

9. The system of claim 1, wherein the data visualization is a word cloud and the display attributes include at least one of:
text size; and
color/shade intensity.

10. A method for providing flexible feedback aggregation and visualization, comprising:
storing, in a synonyms list, a terminology grouping comprising at least a first term and a second term, wherein inclusion of the first term and the second term in the terminology grouping causes the terms to be linked together and to a subtopic-of-interest;
receiving a plurality of feedback records from a plurality of different feedback sources; and
in response to receiving an indication of a selection of a topic-of-interest:
determining feedback records associated with the topic-of-interest;
identifying, in the feedback records determined to be associated with the topic-of-interest, an inclusion of the first term or the second term;
determining metrics associated with the feedback records determined to be associated with the topic-of-interest, wherein the metrics include a frequency of inclusion of the first term or the second term in the feedback records; and
generating a data visualization for display in a user interface, the data visualization including the subtopic-of-interest, wherein display attributes of the subtopic-of-interest are indicative of the frequency of inclusion of the first term or the second term in the feedback records determined to be associated with the topic-of-interest.

11. The method of claim 10, wherein:
receiving the plurality of feedback records comprises receiving at least a portion of the plurality of feedback records via various feedback channels;
receiving the plurality of feedback records comprises receiving a plurality of feedback records including unstructured text; and
due at least in part to the plurality of feedback records being received via various feedback channels or from the plurality of different feedback sources, the unstructured text includes differing terminology to describe a related issue, the differing terminology including the first term and the second term.

12. The method of claim 10, further comprising receiving the terminology grouping and the subtopic-of-interest as an input prior to storing the terminology grouping in the synonyms list.

13. The method of claim 10, wherein storing the terminology grouping in the synonyms list further comprises generating the terminology grouping based on a business rule.

14. The method of claim 10, wherein storing the terminology grouping in the synonyms list comprises use machine learning techniques to determine the terminology grouping.

15. The method of claim 10, wherein receiving the indication of the selection of the topic-of-interest comprises receiving a communication from a frontend application including at least one search term.

16. The method of claim 10, wherein generating the data visualization comprises generating a word cloud.

17. A computer readable storage device that includes executable instructions which, when executed by a processor, cause the processor to perform feedback aggregation and visualization, the instructions comprising:
storing, in a synonyms list, a terminology grouping comprising at least a first term and a second term, wherein inclusion of the first term and the second term in the terminology grouping causes the terms to be linked together and to a subtopic-of-interest;
receiving a plurality of feedback records from a plurality of different feedback sources; and
in response to receiving an indication of a selection of a topic-of-interest:
determining feedback records associated with the topic-of-interest;
identifying, in the feedback records determined to be associated with the topic-of-interest, an inclusion of the first term or the second term;
determining metrics associated with the feedback records determined to be associated with the topic-of-interest, wherein the metrics include a frequency of inclusion of the first term or the second term in the feedback records; and
generating a data visualization for display in a user interface, the data visualization including the subtopic-of-interest, wherein display attributes of the subtopic-of-interest are indicative of the frequency of inclusion of the first term or the second term in the feedback records determined to be associated with the topic-of-interest.

18. The computer readable storage device of claim 17, wherein the first term and the second term are otherwise separate and unrelated.

19. The computer readable storage device of claim 17, wherein the synonyms list is modifiable.

20. The computer readable storage device of claim 17, wherein:
receiving the plurality of feedback records comprises receiving at least a portion of the plurality of feedback records via various feedback channels;
receiving the plurality of feedback records comprises receiving a plurality of feedback records including unstructured text; and
due at least in part to the plurality of feedback records being received via various feedback channels or from the plurality of different feedback sources, the unstructured text includes differing terminology to describe a related issue, the differing terminology including the first term and the second term.
